(19) United States
(12) Patent Application Publication
(10) Pub. No.: US 2006/0003107 A1
(43) Pub. Date: Jan. 5, 2006

(54) Coating with both primer and base coating function, method of producing inmold decoration products and inmold decoration product

(75) Inventors: Tatsuya Itakura, Saitama (JP); Takashi Yamamoto, Saitama (JP); Manabu Yamaoka, Osaka (JP); Toshihiko Uchiyama, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: HONDA MOTOR CO., LTD., Tokyo (JP); NIPPON BEE CHEMICAL CO., LTD., Hirakata-shi (JP)

(21) Appl. No.: 11/165,530

(22) Filed: Jun. 24, 2005

(30) Foreign Application Priority Data
Jun. 25, 2004 (JP) 2004-187600

(51) Int. Cl. B05D 1/36

(52) U.S. Cl. 427/402

(57) ABSTRACT

It is an object of the present invention to provide a coating with both primer and base coating function for an inmold decoration product, which can attain an inmold decoration product which secures adequately the adhesion between a polyolefin substrate and a coating film layer without forming a primer coating film layer and also has excellent properties in a precipitating property of silver, smoothness of a silver-plating layer and coating film appearance, a method of producing inmold decoration products formed by using this base coating composition and an inmold decoration product. A coating with both primer and base coating function for an inmold decoration product, used in a method of producing inmold decoration products obtained by forming a multilayer coating film comprising a silver-plating layer, said multilayer coating film being obtainable by forming a coating film layer with both primer and base coating function, a silver-plating layer and a top clear coating film layer on a polyolefin substrate, wherein said coating with both primer and base coating function comprises a main material (a) based on acrylic polyol (a1), a chlorinated polyolefin modified acrylic resin (a2) and a chlorinated polyolefin resin (a3), and a polyisocyanate curing agent (b), the % by weight of the solids of said (a1), (a2) and (a3) are 40 to 80%, 5 to 45% and 1 to 35%, respectively, and the main material (a) contains cyclohexane in an amount 5 to 45 parts by weight per 100 parts by weight of the solids in the main material.

### TECHNICAL FIELD

The present invention relates to a coating with both primer and base coating function, a method of producing inmold decoration products and an inmold decoration product.

### BACKGROUND ART

Since an inmold decoration product comprising a silver-plating layer on a plastic material exhibits an appearance like a metal, it can be used in automobile interior parts such as a meter cluster, a center cluster, a center console, etc.; automobile exterior parts such as wheel caps, a bumper braid, wheel garnishes, a grille radiator, a back panel, door mirror covers, door handles, etc.; and applications other than automobile's parts such as an air conditioner's housing, a cellular phone, a notebook computer, a cosmetic case, etc.

As a method of producing these inmold decoration products, there is disclosed, for example, a method of forming an undercoat layer on a plastic substrate with a coating composition containing alkoxy titanium ester, a silane coupling agent having epoxy group, an epoxy resin, etc. and then forming a silver-plating layer and a top coat layer in Japanese Kokai Publication Hei-10-309774 (p. 2).

However, in the inmold decoration product obtained by such a method of producing, electroless plating is conducted in forming a silver-plating layer, but performance such as a precipitating property of silver, smoothness of a base coating film layer, adhesion, and coating film appearance were not adequate.

As other methods of producing inmold decoration products, there are also known such methods as described in Japanese Kokai Publication 2002-256454 (p. 2) and Japanese Kokai Publication 2002-2564555 (p. 2). This approach is a method of producing inmold decoration products by forming a base coating film layer comprising an organic resin on a substrate, forming a silver-plating layer thereon and then forming a top coating film layer. However, the inmold decoration product obtained by such a method of producing inmold decoration products was not one which could attain adequately satisfactory physical properties in point of adhesion between the base coating film layer and the silver-plating layer, appearance and film performance. Particularly, since a polyolefin resin has few functional groups on its surface, it is difficult to attain adhesion and therefore it is difficult to attain the adhesion between a polyolefin substrate and a base coating film layer.

It is also known a method of treating the surface of a substrate with a primer and then forming a base coating film layer in order to resolve such a problem. That is, it is a method of forming a primer layer, a base coating film layer, a silver-plating layer and a top coating film layer in succession on a substrate. However, such a method has a problem of an increase in cost due to an additional coating step for coating a primer layer. And, since a substance comprising a resin having a high affinity for a polyolefin substrate is used as a primer layer, it was difficult to be of adequate adhesion between the primer coat layer and the base coating film layer or adequate adhesion of a coating film.

### SUMMARY OF THE INVENTION

In view of the above-mentioned state of the art, it is an object of the present invention to provide a coating with both primer and base coating function for an inmold decoration product, which can attain an inmold decoration product which secures adequately the adhesion between a polyolefin substrate and a coating film layer without forming a primer coating film layer and also has excellent properties in a precipitating property of silver, smoothness of a silver-plating layer and coating film appearance, a method of producing inmold decoration products formed by using this coating composition and an inmold decoration product.

The present invention relates to a coating with both primer and base coating function for an inmold decoration product, used in a method of producing inmold decoration products obtained by forming a multilayer coating film comprising a silver-plating layer, the multilayer coating film being obtainable by forming a coating film layer with both primer and base coating function, a silver-plating layer and a top clear coating film layer are formed on a polyolefin substrate,
wherein the coating with both primer and base coating function comprises a main material (a) based on acrylic polyol (a1), a chlorinated polyolefin modified acrylic resin (a2) and a chlorinated polyolefin resin (a3), and a polyisocyanate curing agent (b), the % by weight of the solids of said (a1), (a2) and (a3) are 40 to 80%, 5 to 45% and 1 to 35%, respectively, and the main material (a) contains cyclohexane in an amount 5 to 45 parts by weight per 100 parts by weight of the solids in the main material.

In the coating with both primer and base coating function for an inmold decoration product of the present invention, it is preferably that the polyisocyanate curing agent (b) is a polyisocyanate compound and that the coating with both primer and base coating function for an inmold decoration product is a two package polyurethane coating composition.

In the coating with both primer and base coating function for an inmold decoration product of the present invention, it is preferably that the polyisocyanate curing agent (b) is a polyisocyanate compound blocked with a blocking agent and that the coating with both primer and base coating function for an inmold decoration product is a one-component polyurethane coating composition.

The present invention also relates to a method of producing inmold decoration products comprising the steps of
(1) forming a coating film layer with both primer and base coating function by applying the above-mentioned coating with both primer and base coating function for an inmold decoration product onto a polyolefin substrate;
(2) forming a silver-plating layer on the coating film with both primer and base coating function formed by the step (1); and
(3) forming a top clear coating film layer on the silver-plating layer formed by the step (2).

The present invention also relates to an inmold decoration product, which is produced by the above-mentioned method of producing inmold decoration products.

### DETAILED DESCRIPTION OF THE INVENTION

Hereinafter, the present invention will be described in more detail.

The coating with both primer and base coating function of the present invention is used in a method of producing inmold decoration products obtained by forming a mutilayer coating film comprising a silver-plating layer, in which a coating film layer with both primer and base coating function, a silver-plating layer and a top clear coating film layer are formed on a polyolefin substrate, and it also has a function as a primer, and therefore it can form a base coating film without treating with a primer. The coating with both primer and base coating function of the present invention is a coating with both primer and base coating function for an inmold decoration product, comprising a main material (a) based on acrylic polyol (a1), a chlorinated polyolefin modified acrylic resin (a2) and a chlorinated polyolefin resin (a3), and a polyisocyanate curing agent (b), characterized in that % by weight of the solids of the above-mentioned (a1), (a2) and (a3) are 40 to 80%, 5 to 45% and 1 to 35%, respectively, and the above-mentioned main material (a) contains cyclohexane in an amount 5 to 45 parts by weight per 100 parts by weight of the solids of the main material (a)

The above-mentioned acrylic polyol (a1) is a component for attaining the adhesion with a silver-plating layer and the smoothness of a silver-plating layer and simultaneously for forming a tough coating film by causing a curing reaction with the polyisocyanate curing agent (b). The adhesion with the surface of a polyolefin material and smoothness can be attained by using the chlorinated polyolefin resin (a3) in addition to the above acrylic polyol (a1). Since the above acrylic polyol (a1) does not have compatibility with the above chlorinated polyolefin resin (a3), the chlorinated polyolefin modified acrylic resin (a2) is used in combination with (a1) and (a2) to attain compatibility.

Acrylic polyol (a1) contained in the above-mentioned main material for a clear coating composition is not particularly limited as long as it is an acrylic resin containing a hydroxyl group and may be a modified resin.

Hydroxyl value of the above acrylic polyol (a1) is preferably 40 to 120 mg KOH/g and more preferably 60 to 100 mg KOH/g. When it is less than 40 mg KOH/g, number of points of a crosslinking reaction with the polyisocyanate curing agent is insufficient and therefore physical properties of a coating film may be inadequate, and when it is more than 120 mg KOH/g, a coating film may become brittle due to too many number of points of a crosslinking reaction, or moisture resistance and water resistance of a coating film may be deteriorated due to excessive hydroxyl groups and it is not preferred.

A weight average molecular weight of the above-mentioned acrylic polyol (a1) is preferably in a range of 20000 to 150000 and more preferably in a range of 40000 to 110000. When it is less than 20000, physical properties of a coating film tend to decrease, and when it is more than 150000, the workability of coating tends to decrease and finished appearance tends to deteriorate. In addition, in the present specification, the weight average molecular weight is a value which is measured, for example, by GPC (gel permeation chromatography) and determined on the polystyrene equivalent basis.

The above-mentioned acrylic polyol (a1) can be obtained by polymerizing monomer compositions comprising a hydroxyl group-containing radically polymerizable monomer and another radically polymerizable monomer to be used as required by a normal method.

The above-mentioned hydroxyl group-containing radically polymerizable monomer is not particularly limited and can include, for example, 2-hydroxyethyl (meth)acrylate, 4-hydroxybutyl (meth) acrylate, 2-hydroxypropyl (meth) acrylate, and a compound obtained by ring-opening 2-hydroxyethyl (meth)acrylate with ε-caprolactone (PRACCEL FA- and FM-series produced by DAICEL CHEMICAL INDUSTRIES, LTD.). These may be used singly or in combination of two or more species.

The above-mentioned another radically polymerizable monomer is not particularly limited and can include, for example, carboxylic acid group-containing monomers such as (meth)acrylic acid, maleic acid, itaconic acid and the like, epoxy group-containing monomers such as glycidyl (meth) acrylate and the like, methyl (meth)acrylate, ethyl (meth)acrylate, isopropyl (meth) acrylate, n-butyl (meth) acrylate, 2-ethylhexyl (meth)acrylate, styrene, vinyl toluene, vinyl acetate and a-methyl styrene. These may be used singly or in combination of two or more species.

The above acrylic polyol (a1) can be obtained by polymerizing the above-mentioned monomer compositions, and as a method of producing the above acrylic polyol (a1), conventional methods of producing acrylic resins, which are publicly known, can be employed. That is, polymerization methods such as solution polymerization, non-aqueous dispersion polymerization and bulk polymerization can be employed, but the solution polymerization is suitable from the viewpoint of the ease of polymerization, the adjustment of molecular weight, and the ease of use in preparing a coating composition.

The above-mentioned chlorinated polyolefin modified acrylic resin (a2) can be obtained by heating a chlorinated polyolefin resin together with a solvent (for example, toluene, butyl acetate, mixed solvent thereof, etc.) to melt this resin and charging a radically polymerizable acrylic monomer composition together with a radical initiator into the melted chlorinated polyolefin resin to react those.

The chlorinated polyolefin resin used for producing the above chlorinated polyolefin modified acrylic resin (a2) is a portion comprising chlorine-substituted polyolefin. As the above polyolefin, there are given, for example, polyethylene, polypropylene, ethylene-propylene copolymer, ethylene-propylene-diene copolymer, polybutene and hydrogenated product of copolymers such as styrene-butadiene-isoprene. These compounds may be used singly or in combination of two or more species. It is particularly preferred since a material is easily available and resulting adhesion becomes higher when the chlorinated polyolefin portion comprises chlorine-substituted polypropylene.

A chlorine content and an a molecular weight of the chlorinated polyolefin portion in the above chlorinated polyolefin modified acrylic resin (a2) are not particularly limited but when the chlorine content is 18 to 30% by weight and the molecular weight of the chlorinated polyolefin portion is 20000 to 150000, it is preferred since the adhesion with a polyolefin material is further improved and resistance to gasoline becomes high. It is more preferred that the chlorine content is 20 to 25% by weight and the molecular weight of the chlorinated polyolefin portion is 50000 to 120000. When the chlorine content of the chlorinated polyolefin portion is less than 18% by weight, compatibility with another resin is reduced, and resin has high crystallinity and becomes resistant to melting, leading to the reduction of a film forming property. On the other hand, when the chlorine content is more than 30% by weight, the adhesion with the polyolefin substrate is reduced. And, when the molecular weight of the chlorinated polyolefin portion is less than 20000, strength of a coating film to be obtained from a primer coating composition is low and water resistance and resistance to gasoline are reduced. On the other hand, when the molecular weight is more than 150000, wettability with a polyolefin substrate is reduced to deteriorate the adhesion and the compatibility with another resin and therefore a coating film may become uneven and cause haze.

The chlorinated polyolefin portion in the above chlorinated polyolefin modified acrylic resin (a2) may be chlorinated polyolefin modified with carboxylic acid and/or acid anhydride to an extent not decreasing water resistance. As the carboxylic acid and/or acid anhydride to be used for modifying, there can be given maleic acid, fumaric acid, maleric anhydride, citraconic acid, citraconic anhydride, itaconic acid and itaconic anhydride and the like. The proportion of the resin to be modified with these compounds is determined in consideration of water resistance or the like and it is generally 7% or less and preferably 5% or less.

As commercially available chlorinated polyolefin which can be used as a chlorinated polyolefin portion in the above chlorinated polyolefin modified acrylic resin (a2), there can be given, for example, HARDLEN EH202 or HARDLEN 14ML, HARDLEN M128P (all produced by Toyo Kasei Kogyo Co., Ltd.) and SUPERCHLON 822 (produced by Nippon Paper Group, Inc.)

An acrylic polymerized chain portion in the above chlorinated polyolefin modified acrylic resin (a2) is a polymerized chain which is grafted to the chlorinated polyolefin portion. A glass transition temperature of the acrylic polymerized chain portion is not particularly limited as long as it is within a range of 0 to 60° C. When the glass transition temperature is lower than 0° C., the adhesion with a polyolefin material is reduced. On the other side, when the glass transition temperature is higher than 60° C., the compatibility of the acrylic polymerized chain portion with the chlorinated polyolefin portion is poor and a flow property is deteriorated in a hot condition. Further, when it is higher than 60° C., a coating film to be obtained from a primer coating composition is not smooth and further it is hard and is lacking flexibility.

The acrylic polymerized chain portion in the above chlorinated polyolefin modified acrylic resin (a2) contains a structural unit derived from an acrylic monomer as an essential component but it may be a copolymer portion further containing a structural unit derived from another monomer appropriately. As an acrylic monomer, there can be given, for example, acrylic acid and acrylic acid ester monomer such as (meth) acrylic monomer exemplified as a monomer which can be used in producing the acrylic polyol (a1) described above. These compounds may be used singly or in combination of two or more species.

As another monomer, there can be given, for example, styrenic monomers such as styrene, vinyl toluene, α-methyl styrene, etc.; hydroxyl group-containing vinyl monomers such as 4-hydroxybutyl vinyl ether, p-hydroxystyrene, etc.; epoxy group-containing monomer such as allyl glycidyl ethers, etc. These compounds may be used singly or in combination of two or more species.

In any case, a structural unit derived from acrylic monomer or another monomer is selected in such a way that a glass transition temperature of the acrylic polymerized chain portion is within a range of 0 to 60° C. As an acrylic polymerized chain portion satisfying the conditions of a glass transition temperature like this, there are given, for example, a compound containing a structural unit derived from butyl acrylate as a main component and appropriately a structural unit derived from styrene, acrylic acid, methyl methacrylate, 2-hydroxyethyl methacrylate or the like as a secondary component, and a compound containing a structural unit derived from cyclohexyl methacrylate as a main component and appropriately a structural unit derived from styrene, 2-ethylhexyl acrylate, 2-hydroxyethyl acrylate or the like as a secondary component.

As a method of producing the above chlorinated polyolefin modified acrylic resin (a2), there is, for example, a method of previously dissolving chlorinated polyolefin resin in a solvent and conducting graft polymerization of the above acrylic monomer or another monomer with the dissolved chlorinated polyolefin resin in a solvent in the presence of peroxide, and a method of polymerizing a solution of a raw material monomer of chlorinated polyolefin or the like together with the above acrylic monomer or another monomer in a solvent.

A weight ratio of the chlorinated polyolefin portion (a2-1) to the acrylic polymerized chain portion (a2-2) in the above chlorinated polyolefin modified acrylic resin (a2) is not particularly limited but it is preferably within a range of (a2-1)/(a2-2)=80/20 to 10/90 and more preferably within a range of (a2-1)/(a2-2)=70/30 to 30/70. When the above-mentioned weight ratio is less than 10/90, the weight ratio of the chlorinated polyolefin portion becomes small and therefore the adhesion with the polyolefin material may be reduced. On the other hand, when the above-mentioned weight ratio is more than 80/20, the weight ratio of the acrylic polymerized chain portion becomes small and therefore water-dispersibility may be deteriorated.

The above chlorinated polyolefin resin (a3) is a resin comprising chlorine-substituted polyolefin and it is possible to use a substance similar to a chlorinated polyolefin resin (a3) to be used for producing the chlorinated polyolefin modified acrylic resin (a2) described above. In the coating composition of the present invention, the above chlorinated polyolefin resin (a3) may be the same one as that used for producing the chlorinated polyolefin modified acrylic resin (a2) to be used in combination or may be the different one.

In the above main material (a), the acrylic polymer (a1) is 40 to 80% by weight with respect to 100% by weight of the solids content. When the content of the above acrylic polymer (a1) is less than 40% by weight, the gloss of the inmold decoration product to be obtained is deteriorated, and when it is more than 80% by weight, the adhesion with the surface of the polyolefin substrate or the silver-plating layer is reduced. More preferably, the above lower limit is 45% by weight and the above upper limit is 76% by weight.

In the above main material (a), the chlorinated polyolefin modified acrylic resin (a2) is 5 to 45% by weight with respect to 100% by weight of the solids content. When the content of the above chlorinated polyolefin modified acrylic resin (a2) is less than 5% by weight, the stability of the main material of a coating composition becomes poor and the precipitating property of silver at the point of forming silver-plating of an upper layer becomes uneven and its gloss is deteriorated, and when it is more than 45% by weight, the adhesion with a plastic substrate of a lower layer or the silver-plating layer is reduced. More preferably, the above lower limit is 10% by weight and the above upper limit is 40% by weight.

In the above main material (a), the chlorinated polyolefin resin (a3) is 1 to 35% by weight with respect to 100% by weight of the solids content. When the content of the above chlorinated polyolefin resin (a3) is less than 1% by weight, the adhesion with a plastic material is reduced, and when it is more than 35% by weight, its gloss is deteriorated. More preferably, the above lower limit is 3% by weight and the above upper limit is 33% by weight.

The above main material (a) contains cyclohexane in an amount 5 to 45 parts by weight per 100 parts by weight of the solids in the above main material (a) in addition to the acrylic polyol (a1), the chlorinated polyolefin modified acrylic resin (a2) and the chlorinated polyolefin resin (a3), and a polyisocyanate curing agent (b). When the content of cyclohexane is less than 5 parts by weight, the stability of chlorinated polyolefin resin (a3) of the main material of a coating composition cannot be maintained and consequently the stability of the main material of a coating composition is deteriorated and gloss of the inmold decoration product is deteriorated. When it is more than 45 parts by weight, solubility of the acrylic polyol (a1) becomes poor and problems such as a deterioration of smoothness of the silver-plating layer or the top clear coating film layer and a deterioration of gloss of the inmold decoration product may arise. Preferably, the above lower limit is 7 parts by weight and the above upper limit is 40 parts by weight. Further, the above specification of the cyclohexane content represents an amount of cyclohexane with respect to 100 parts by weight of the total solids of (a1), (a2) and (a3) in a coating composition when the coating with both primer and base coating function for an in mold decoration product of the present invention is a one-component base coating composition.

The coating with both primer and base coating function of the present invention uses a polyisocyanate curing agent (b) in addition to the above main material (a). The above-mentioned polyisocyanate curing agent (b) may be used as a two package polyurethane coating composition in which an polyisocyanate compound not blocked is reserved separately from the above main material (a) and mixed with the main material in use, or may be used as a one-component polyurethane coating composition in which a blocked polyisocyanate compound is used.

The above-mentioned polyisocyanate compound is not particularly limited as long as it is a compound having two or more isocyanate groups and can include, for example, aromatic isocyanates such as trilenediisocyanate, 4,4′-diphenylmethane diisocyanate, xylylene diisocyanate, m-xylylene diisocyanate and the like; aliphatic isocyanates such as hexamethylene diisocyanate and the like; alicyclic isocyanates such as isophorone diisocyanate and the like; and monomers thereof and polymers of a biuret type, an isocyanurate type and adduct type thereof. The above polyisocyanate is preferably a polymer because of a good curability.

As a commercially available product of the above polyisocyanate, there can be given Sumidur N75, Sumidur N3600, Sumidur N3200-90CX (all produced by Sumitomo Bayer Urethane Co., Ltd.); Coronate FH, Coronate 341 (both produced by NIPPON POLYURETHANE INDUS TRY CO., LTD.) and DURANATE THA-100, DURANATE 24A-90CX, DURANATE E-402-90T (all produced by ASAHI KASEI CORPORATION).

A blocking agent used for blocking the above polyisocyanate is not particularly limited and can include, for example, phenols such as phenol, cresol, xylenol, chlorophenol and ethylphenol; lactams such as ε-caprolactam, δ-valerolactam, γ-butyrolactam and β-propiolactam; active methylenes such as ethyl acetoacetate and acetyl acetone; alcohols such as methanol, ethanol, propanol, isopropanol, n-butanol, isobutanol, t-butyl alcohol, amyl alcohol, ethylene glycol monomethyl ether, ethylene glycol monoethyl ether, ethylene glycol monomethyl ether, ethylene glycol mono2-ethylhexyl ether, propylene glycol monomethyl ether, methyl glycolate, butyl glycolate, diacetone alcohol, methyl lactate and ethyl lactate and furfuryl alcohol; oximes such as formaldoxime, acetaldoxime, acetoxime, methyl ethyl ketoxime, diacetylmonoxime and cyclohexane oxime; mercaptans such as butyl mercaptan, hexyl mercaptan, t-butyl mercaptan, thiophenol, methylthiophenol and ethylthiophenol; acid amides such as acetic acid amide and benzamide; imides such as succinimide and maleimide; imidazoles such as imidazole and 2-ethylimidazole; and secondary amines such as dimethylamine, diethylamine and dibutylamine.

As a commercially available product of the above blocked isocyanate, there can be given, for example, Desmotherm 2170, DesmodurTPLS2759 (both produced by Sumitomo Bayer Urethane Co., Ltd.); Coronate C-2513, BI-120 (both produced by NIPPON POLYURETHANE INDUSTRY CO., LTD.); and DURANATE MF-K60X (produced by ASAHI KASEI CORPORATION) as a substance obtained by reacting active methylene, and Desmodur BL3175, Desmodur TPLS2135, Desmodur S-2759-40X (all produced by Sumitomo Bayer Urethane Co., Ltd.); and Coronate C2557, Coronate 2529, Coronate C2507 (all produced by NIPPON POLYURETHANE INDUSTRY CO., LTD.) as a substance obtained by reacting methyl ketone oxime.

In the coating with both primer and base coating function of the present invention, the equivalence ratio of an NCO group in the above curing agent of polyisocyanate (b) to an OH group in the above acrylic polyol (a1) (NCO/OH) preferably ranges from 1/1 to 2/1. When the equivalence ratio is less than 1/1, since the adhesion of a base coating film layer to a silver-plating layer may be deteriorated, it is not preferred. When it is more than 2/1, a rainbow may be generated in an inmold decoration product. The above-mentioned equivalence ratio (NCO/OH) is more preferably within a range of 1.1/1 to 1.95/1.

A component such as another solvents, a curing catalyst, a surface conditioner, an anti-settling agent, a defoaming agent and a viscosity modifier may be added to the coating with both primer and base coating function of the present invention as required. As a particularly preferable additive, there can be given a high molecular weight surface conditioner such as organic modified polydimethylsiloxane for maintaining a precipitating property or smoothness of a silver-plating film and epoxysilane for maintaining adhesion or corrosion resistance by reacting with the surface of a silver film.

When the above base coating composition is a two package polyurethane coating composition comprising the main material (a) and the isocyanate compound, the above base coating film layer can be formed by mixing the above two components immediately before use and applying the mixture. Formation of the base coating film layer by coating with the above base coating composition can be carried out by a usual method such as spray coating. After applying a coating composition, heat setting was conducted at a temperature of 60 to 100° C. and it is preferred to obtain a coating film having a cured film thickness of 20 to 30 μm.

When the above base coating composition is a one-component polyurethane coating composition comprising the main material (a) and the blocked isocyanate compound, coating can be carried out by a usual method such as spray coating. After applying a coating composition, heat setting was conducted at a temperature of 70 to 100° C. and it is preferred to obtain a coating film having a cured film thickness of 20 to 30 μm.

A method of forming the mutilayer coating film of the present invention is conducted by forming the silver-plating layer on the above base coating film layer. By forming the silver-plating layer on the above base coating film layer, it is possible to form a silver-plating layer which has a highly precipitating property of silver and is superior in appearance and adhesion.

A method of forming the silver-plating layer is not particularly limited and it can be conducted by electroless plating referred to as a silver mirror reaction. As the most popular method, there can be given a method of applying ammoniacal silver nitrate ([Ag (NH₃)₂]⁺OH⁻) referred to as Tollen's reagent and a reductant solution to the above base coating film layer so as to be mixed on the surface of the coating film. The above-mentioned reductant is not particularly limited and can include, for example, saccharides such as glucose or the like; organic compounds containing an aldehyde group such as glyoxal or the like; sodium nitrite and sodium thiosulfate.

A method of forming the mutilayer coating film of the present invention is conducted by providing a clear coating film layer on the above silver-plating layer. Thereby, the silver-plating layer is protected from degradation and corrosion resistance is enhanced. Also, the appearance of a laminated product is more enhanced.

As a top clear coating composition for forming the above top coating film layer, there can be used a coating composition which is generally used as a top clear coating composition in the mutilayer coating film of an inmold decoration product comprising the above silver-plating layer. Particularly, a top clear coating composition, which gives consideration to interlaminar adhesion of the top clear coating film and the silver-plating film, corrosion resistance of the silver-plating layer and weather resistance, is preferred. Atop clear coating composition containing an acrylic resin is preferred from the viewpoint of weather resistance and it may be one containing an amino group-containing resin and a rust preventive agent from the viewpoint of attaining adhesion or corrosion resistance of a silver-plating film.

The above-mentioned acrylic resin is preferably a reactive hydroxyl group-containing acrylic polyol in order to attain good film properties. The above-mentioned reactive hydroxyl group-containing acrylic polyol can employ resins similar to the above acrylic polyol (a1). And, as the commercially available acrylic polyol resin, there can be used DIANAL LR-2586 (produced by MITSUBISHI RAYON CO., LTD.) and HITALOID 3371 (produced by Hitachi Chemical Co., Ltd.). The above reactive hydroxyl group-containing acrylic polyol may be a solution type resin or a non-aqueous dispersion (NAD) resin. As a commercially available product of the above non-aqueous dispersion resin, there can be given Setalux 1850SS-50 (produced by Akzo Nobel K. K) and HITALOID 6110 (produced by Hitachi Chemical Co., Ltd.).

As the above-mentioned amino group-containing resin, an acrylic resin containing an amino group is preferred and an acrylic resin having a dialkylamino group, expressed by —N—R₂, in a side chain is more preferred. The above amino group-containing resin can be obtained by further using a tertiary amino group-containing radically polymerizable monomer as a monomer in a method of producing similar to that of the above acrylic polyol (a1).

The above-mentioned clear coating composition preferably contains a curing agent. A curing agent is not particularly limited and can include, for example, polyisocyanate, etc. As the above polyisocyanate, there can be used the polyisocyanate described above which can be used in the coating with both primer and base coating function and a blocked polyisocyanate compound may also be used. Aliphatic polyisocyanates and/or alicyclic polyisocyanates are preferred because of excellent weather resistance.

As the above-mentioned rust preventive agent, there can be given a fatty acid modified amide compound. Another solvents such as butyl acetate ester, xylene and toluene; a curing catalyst; a light stabilizer such as SANOL LS-292 (produced by SANKYO CO., LTD.); an ultraviolet absorber such as TINUVIN 384: a surface conditioner; a defoaming agent; a viscosity modifier; and an anti-settling agent may be blended in the above top clear coating composition as required.

In the above clear coating composition, coating is carried out by mixing the above respective components immediately before use. Formation of the clear coating film layer by coating with the above clear coating composition can be carried out by a usual method such as spray coating. After applying a coating composition, heat setting was conducted at a temperature of 60 to 100° C. and it is preferred to obtain a coat having a cured film thickness of 20 to 40 μm. When the dry film thickness is less than 20 μm, corrosion resistance and appearance may be deteriorated. When it is more than 40 μm, it is not preferred in that popping or sagging becomes apt to occur. A dry film thickness of the above clear coating film layer is more preferably 25 to 35 μm.

As a plastic material to which the method of forming the mutilayer coating film of the present invention is applied, polyolefinic material is preferred and polypropylene (PP), olefinic thermoplastic elastomers (TPO) and a mixture thereof can be given. As these materials, there can be used one molded by publicly known methods of molding such as injection molding, extrusion molding or the like.

The above plastic material does not necessarily require treating the surface of the plastic material prior to applying the coating with both primer and base coating function of the present invention, but, in the case where there may be contaminants adhering after molding, it is preferred to conduct cleaning treatment and drying prior to applying the coating with both primer and base coating function in order to make the adhesion better. The above drying treatment and drying may be conducted by a usual procedure.

A method of forming the mutilayer coating film of the present invention is conducted by forming the silver-plating layer on the above base coating film layer. By forming the silver-plating layer on the above base coating film layer, it is possible to form a silver-plating layer which has a highly precipitating property of silver and is superior in appearance and adhesion. An inmold decoration product obtained by such a method also constitutes the present invention.

The coating with both primer and base coating function of the present invention can attain an inmold decoration product which secures adequately the adhesion between a polyolefin substrate and a coating film layer without forming a primer coating film layer and also has excellent properties in a precipitating property of silver, smoothness of a silver-plating layer and a coating film appearance.

### BEST MODE FOR CARRYING OUT THE INVENTION

Hereinafter, the present invention will be described in more detail by way of examples, but the present invention is not limited to these examples. In addition, “part(s)” refers to “part(s) by weight” and “%” means “% by weight” in Examples, unless otherwise specified.

### PRODUCTION EXAMPLE 1

### Preparation of acrylic polyol (a1)

Into a reaction container equipped with a stirrer, a thermometer, a reflux tube, a dropping funnel, a nitrogen gas inlet pipe and a heating apparatus with a thermostat, 2 parts by weight of propylene glycol monomethyl ether (PGME), 8.57 parts by weight of butyl acetate, 8.57 parts by weight of toluene and 5 parts by weight of aromatic hydrocarbon solvent (“Solvesso 100” produced by ExxonMobil Corporation) were charged and an internal temperature was elevated to 110° C. while stirring.

Next, a mixed solution of 37.35 parts by weight of methylmethacrylate, 2.07 parts by weight of methacrylic acid, 44.08 parts by weight of n-butyl methacrylate and 16.5 parts by weight of hydroxypropyl acrylate and an initiator solution comprising 1 part by weight of PGME, 4 parts by weight of butyl acetate, 4 parts by weight of toluene and 1 part by weight of “Solvesso 100” and 2.2 parts by weight of a peroxide polymerization initiator (“Kayaester O” produced by NIPPON KAYAKU CO., LTD.) were separately put in two dropping funnels, respectively, and added dropwise over 3 hours to start polymerization. During this time, the internal temperature was kept at 110° C. and after adding dropwise, subsequently, a solution comprising 1 part by weight of PGME, 1.5 parts by weight of butyl acetate, 1 part by weight of “Solvesso 100”, 1.5 parts by weight of toluene and 0.3 parts by weight of “Kayaester O” was added dropwise over 2 hours while keeping the inside temperature of the reaction container at 110° C. to complete the polymerization. The inside temperature was cooled to 80° C. and then 40.76 parts by weight of toluene and 17 parts by weight of butyl acetate were charged in succession to obtain acrylic resin varnish A. The solids content of the acrylic resin varnish was 50% by weight.

And, a weight average molecular weight was about 70000 from the measurement on the styrene equivalent basis of gel permeation chromatography.

In addition, in the method of measuring the above-mentioned solids content of the acrylic resin varnish, a sample of the acrylic resin varnish (X g) was taken on an aluminum pan for measuring nonvolatile matter and dried at 110° C. for 3 hours, and then an amount (Y g) of remaining solids was measured to determine the solids content according to the following equation.
solids content of resin (% by weight) [(Y)/(X)]×100

### PRODUCTION EXAMPLE 2

### Preparation of Chlorinated Polyolefin Resin Varnish (Polyolefin Resin Varnish a3)

Into a reaction container equipped with a stirrer, a thermometer, a reflux tube, a dropping funnel, a nitrogen gas inlet pipe and a heating apparatus with a thermostat, 56 parts by weight of toluene, 24 parts by weight of butyl acetate and 20 parts by weight of acid anhydride modified chlorinated polypropylene resin (“HARDLEN M128P” produced by Toyo Kasei Kogyo Co., Ltd., chlorine content 21% by weight, weight average molecular weight 40000) were charged and an internal temperature was elevated to 110° C. while stirring and a sample was heated for 1 hour to obtain polyolefin resin varnish B. The solids content of the resin varnish was 20% by weight.

### PRODUCTION EXAMPLE 3

### Preparation of Chlorinated Polypropylene Modified Acrylic Resin (Polyolefin Resin Varnish a2)

Into a reaction container equipped with a stirrer, a thermometer, a reflux tube, a dropping funnel, a nitrogen gas inlet pipe and a heating apparatus with a thermostat, 7 parts by weight of propylene glycol monomethyl ether (PGME), 58 parts by weight of toluene, 23 parts by weight of butyl acetate and 20 parts by weight of acid anhydride modified chlorinated polypropylene resin (“HARDLEN M128P” produced by Toyo Kasei Kogyo Co., Ltd.) were charged and an internal temperature was elevated to 110° C. while stirring. Next, a mixed monomer solution comprising 30 parts by weight of methylmethacrylate, 3 parts by weight of methacrylic acid, 40 parts by weight of n-butyl methacrylate and 7 parts by weight of 2-hydroxyethyl metacrylate and a polymerization initiator solution comprising 4 parts by weight of propylene glycol monomethyl ether, 12 parts by weight of toluene, 5 parts by weight of butyl acetate and 2.2 parts by weight of a peroxide base polymerization initiator (“Kayaester O” produced by NIPPON KAYAKU CO., LTD.) were separately put in two dropping funnels, respectively, and added dropwise over 3 hours while keeping the inside of the reaction container at 110° C. and stirring the content. Further, a polymerization initiator solution comprising 1 part by weight of propylene glycol monomethyl ether, 2 parts by weight of toluene, 1 part by weight of butyl acetate and 0.3 parts by weight of “Kayaester O” was added dropwise over 2 hours while keeping the inside of the reaction container at 110° C. and stirring the content to complete the reaction. The solids content of this resin was 47% by weight.

### PRODUCTION EXAMPLE 4

### Preparation of Coating Solution of the Coating with Both Primer and Base Coating Function (A)

First, each of the above main materials (a) was charged into a container equipped with a stirrer immediately before coating for the two package polyurethane coating composition and previously for the one-component polyurethane coating composition, and a dilution solvent (D) (butyl acetate ester/methyl isobutyl ketone/toluene/Ipsol=35/10/32/23: weight ratio) was charged into the above main material (a) in a ratio of the dilution solvent to the main material of 1:1 while stirring and subsequently into this, each isocyanate curing agent was charged, and the mixture was stirred for 15 minutes to prepare a coating solution of a coating with both primer and base coating function (A).

Two package polyurethane coating composition: Sumidur N-3500 (produced by Sumitomo Bayer Urethane Co., Ltd., nonvolatile matter content 75%) was used as an isocyanate curing agent. One-component polyurethane coating composition: Desmodur LS2759-40X (produced by Sumitomo Bayer Urethane Co., Ltd., nonvolatile matter content 38%), blocked isocyanate, was used as an isocyanate curing agent.

An amount of the curing agent to be blended in respective Examples and Comparative Examples are shown in Tables 1 to 3.

### PRODUCTION EXAMPLE 5

### Preparation of Coating Solution of Top Clear Coating Composition (c1)

Each coating solution of a top clear coating composition (c1) for Examples 1 to 6, Example 9 and Comparative Examples 1 to 7 was prepared by diluting 100 parts of the top clear coating composition using R241 top clear (produced by NIPPON BEE CHEMICAL CO., LTD., two package polyurethane coating composition) with 50 parts of the above dilution solvent B.

### PRODUCTION EXAMPLE 6

### Preparation of Coating Solution of Top Clear Coating Composition (c2)

As for a clear coating composition (c2) in Example 7, into a container equipped with a stirrer, 167 parts of an acrylic polyol resin “DIANAL LR-2586” (produced by MITSUBISHI RAYON CO., LTD., nonvolatile matter content 45%), 52 parts of a tertiary amino group-containing acrylic resin “ACRYDIC GZ-169” (produced by DAINIPPON INK AND CHEMICALS, INCORPORATED, nonvolatile matter content 48%), 2 parts of a surface conditioner “SH 2000-100CS” (produced by Dow Corning Toray Silicone Co., Ltd.), 1 part of a light stabilizer “SANOL LS-292” (produced by SANKYO CO., LTD.), 3.6 parts of an ultraviolet absorber “TINUVIN 384” (produced by Ciba Specialty Chemicals K.K., xylene solution containing 90% solids) and 16 parts of butyl acetate ester were charged in succession while stirring and mixing to prepare a main material of a clear coating composition. Prior to coating, the above dilution solvent (D) was charged into the above main material in the weight ratio of the dilution solvent to the main material of 1:1 while stirring to dilute the main material and subsequently into this, 16 parts of a two package polyisocyanate curing agent “DURANATE 24A-90PX” (produced by ASAHI KASEI CORPORATION, nonvolatile matter content 90%) was charged to prepare a coating solution of a clear coating composition. This coating solution was used for forming a clear coating film of Example 7.

### PRODUCTION EXAMPLE 7

### Preparation of Coating Solution of Top Clear Coating Composition (c3)

A main material of a clear coating composition was prepared by following the same procedure as in the above (c2) using 167 parts of an acrylic polyol resin “DIANAL LR-2586”, 50 parts of a non-aqueous dispersion acrylic resin “Setalux 1850SS-50” (produced by Akzo Nobel K.K., nonvolatile matter content 50%), 2 pats of “SH 2000-100CS”, 1.7 parts of “SANOL LS-292”, 4.6 parts of “TINUVIN 384” and 38 parts of butyl acetate ester. This main material was diluted with the amount of the above dilution solvent (D) in a ratio of 1:1 in the same manner as in the above (c2), and then to this, 16 parts of “DURANATE 24A-90PX was added and the mixture was stirred for 15 minutes to prepare a coating solution of a clear coating composition. This coating solution was used for forming a top clear coating film of Example 8.

(Preparation of Test Piece)

Pretreatment of Polypropylene Substrate and Formation of a Coating Film with Both Primer and Base Coating Function

A polypropylene substrate having a size of 70 mm×100 mm×3 mm was cleaned with isopropanol and dried, and then to this, the above coating with both primer and base coating function was applied by spraying in such a way that a dry film thickness is 18 μm and dried at 80° C. for 10 minutes.

(Formation of Silver-Plating Layer)

Hydrochloric acid solution of 0.2% tin chloride (II) was applied onto the surface of the above-mentioned test piece, in which the base coating film layer was formed, and then water-washed. To the water-washed test piece, a mixed aqueous solution of silver nitrate and excessive ammonia and a glucose solution were simultaneously applied to form a uniform silver-plating film of about 20 μm in thickness. By removing a residual fraction through water-washing, a test piece in which the silver-plating layer was formed on the above base coating film layer was obtained.

Formation of Clear Coating Film Layer

Each clear coating composition described above was applied by spraying onto the above-mentioned test piece in which the silver-plating layer was formed in such a way that a thickness of a cured film is 30 μm, and cured at 80° C. for 20 minutes to obtain a test piece provided with a clear coating film layer.

The resulting test piece was evaluated by the following evaluation methods. The results of evaluation are shown in Tables 1 and 2.

(Evaluation Method)

Storage Stability

As for two package curable coating with both primer and base coating function in the respective Examples and Comparative Examples, 200 g of each main material (a) was put in a 500 ml tin can container and sealed, and as for one-component curable coating compositions, 200 g of each coating composition was done similarly. After storing each coating composition at 40° C. for 10 days, the sample was stirred with a glass rod and rated in accordance with the following criteria.
◯: There is no thickening in a composition.
X: There is significant thickening or gelation.
   Precipitating Property of Silver

A state of the formation of the silver-plating layer was visually observed and rated in accordance with the following criteria
◯: A silver-plating layer is uniformly formed.
X: A silver-plating layer is not uniformly formed.
   Coating Film Appearance

The appearances of the test pieces of Examples and Comparative Examples were visually observed in accordance with the following criteria.
◯: There is no abnormal appearance such as an interference fringe, haze, blushing and defective smoothness.
X: There is an abnormal appearance such as an interference fringe, haze, blushing and defective smoothness.
   Adhesion; Adhesion After Water-Soak Test

After being immersed in hot water of 40° C. for 10 days, the test piece was taken out and after water was wiped off the surface of the test piece, the test piece was left standing at 25° C. for 1 hour. Then, a cross-cut test (peeling test with a cellotape) was conducted according to JIS K 5400. The results were rated based on the following criteria.
◯: There is no peeling of lattice and no chips in a cut portion.

X: There are peeling of lattice or chips in a cut portion.

TABLE 1

| | | | Example | | Example | | Example | | Example | | Example | | Example | | Ex- | Ex- |
|---|---|---|---|---|---|---|---|---|---|---|---|---|---|---|---|---|
| | | NV | 1 | | 2 | | 3 | | 4 | | 5 | | 6 | | ample 7 | ample 8 |
| | | % | solids | solution | solids | solution | solids | solution | solids | solution | solids | solution | solids | solution | solids | solution |
| 1-1:Main | a1:acrylic | 50 | 62 | 124 | 45 | 90 | 75 | 150 | 50 | 100 | 65 | 130 | 62 | 124 | same | same |
| material of | polyol | | | | | | | | | | | | | | coating | coating |
| coating | a2:CLPP | 47 | 23 | 49 | 23 | 49 | 21 | 45 | 40 | 85 | 10 | 21 | 23 | 49 | with | with |
| composi- | modified | | | | | | | | | | | | | | both | both |
| tion | Ac | | | | | | | | | | | | | | primer | primer |
| (a) | a3:CLPP | 20 | 15 | 75 | 32 | 160 | 4 | 20 | 10 | 50 | 25 | 125 | 15 | 75 | base | base |
| subtotal | | | 100 | | 100 | | 100 | | 100 | | 100 | | 100 | | coating | coating |
| cyclohexane | | | | 24 | | 24 | | 24 | | 24 | | 7 | | 40 | function | function |
| toluene | | | | 112 | | 61 | | 145 | | 125 | | 101 | | 96 | as in | as in |
| total | | | (100) | 384 | | 384 | | 384 | | 384 | | 384 | | 384 | Ex- | Ex- |
| NV % | | | | 26 | | 26 | | 26 | | 26 | | 26 | | 26 | ample | ample |
| 1-2:Curing | b1:NCO | 75 | 20 | 27 | 20 | 27 | 20 | 27 | 20 | 27 | 20 | 27 | 20 | 27 | 1 | 1 |
| agent | compound | | | | | | | | | | | | | | | |
| solution | | | | | | | | | | | | | | | | |

| | | | | | | | | | | | | |
|---|---|---|---|---|---|---|---|---|---|---|---|---|
| total | 120 | 411 | 120 | 411 | 120 | 411 | 120 | 411 | 120 | 411 | 120 | 411 |
| Equivalence ratio | | | | | | | | | | | | |
| (NCO/OH) | | | | | | | | | | | | |
| Final two - package | 29 | | 29 | | 29 | | 29 | | 29 | | 29 | |
| coating composition | | | | | | | | | | | | |
| nonvolatile (NV) % | | | | | | | | | | | | |

| | | | | | | | | |
|---|---|---|---|---|---|---|---|---|
| Top clear (c) | clear (c1) | clear (c1) | clear (c1) | clear (c1) | clear (c1) | clear (c1) | (c2) | (c3) |
| Adhesion | ◯ | ◯ | ◯ | ◯ | ◯ | ◯ | ◯ | ◯ |
| Appearance | ◯ | ◯ | ◯ | ◯ | ◯ | ◯ | ◯ | ◯ |
| (transparency, | | | | | | | | |
| gloss, interference | | | | | | | | |
| fringe, smoothness) | | | | | | | | |
| Storage stability | ◯ | ◯ | ◯ | ◯ | ◯ | ◯ | ◯ | ◯ |
| Precipitating property | ◯ | ◯ | ◯ | ◯ | ◯ | ◯ | ◯ | ◯ |
| of silver | | | | | | | | |

TABLE 2

| | | | Comparative | | Comparative | | Comparative | | Comparative | | Comparative | | Comparative | |
|---|---|---|---|---|---|---|---|---|---|---|---|---|---|---|
| | | NV | Example 1 | | Example 2 | | Example 3 | | Example 4 | | Example 5 | | Example 6 | |
| | | % | solids | solution | solids | solution | solids | solution | solids | solution | solids | solution | solids | solution |
| 1-1:Main | a1:acrylic polyol | 50 | 35 | 70 | 85 | 170 | 75 | 150 | 35 | 70 | 62 | 124 | 70 | 140 |
| material of | a2:CLPP modified Ac | 47 | 25 | 53 | 10 | 22 | 0 | 0 | 50 | 106 | 23 | 49 | 30 | 64 |
| coating | a3:CLPP | 20 | 40 | 200 | 5 | 25 | 25 | 125 | 15 | 75 | 15 | 75 | 0 | 0 |
| composition | | | | | | | | | | | | | | |
| (a) | | | | | | | | | | | | | | |
| subtotal | | | 100 | | 100 | | 100 | | 100 | | 100 | | 100 | |
| cyclohexane | | | | 24 | | 24 | | 24 | | 24 | 0 | 0 | | 24 |
| toluene | | | | 37 | | 143 | | 85 | | 109 | | 136 | | 156 |
| total | | | (100) | 384 | | 384 | | 384 | | 384 | | 384 | | 384 |
| NV % | | | | 26 | | 26 | | 26 | | 26 | | 26 | | 26 |
| 1-2:Curing | b1:NCO compound | 75 | 20 | 27 | 20 | 27 | 20 | 27 | 20 | 27 | 20 | 27 | 20 | 27 |
| agent solution | | | | | | | | | | | | | | |

| | | | | | | | | | | | | |
|---|---|---|---|---|---|---|---|---|---|---|---|---|
| total | 120 | 411 | 120 | 411 | 120 | 411 | 120 | 411 | 120 | 411 | 120 | 411 |
| Equivalence ratio (NCO/OH) | | | | | | | | | | | | |
| Final two - package coating | 29 | | 29 | | 29 | | 29 | | 29 | | 29 | |
| composition nonvolatile (NV) % | | | | | | | | | | | | |

| | | | | | | |
|---|---|---|---|---|---|---|
| Top clear (c) | clear (c1) | clear (c1) | clear (c1) | clear (c1) | clear (c1) | clear (c1) |
| Adhesion | ◯ | X | ◯ | ◯ | ◯ | X |
| Appearance (transparency, gloss, | X | ◯ | X | ◯ | ◯ | ◯ |
| interference fringe, smoothness) | | | | | | |
| Storage stability | ◯ | ◯ | X | ◯ | ◯ | ◯ |
| Precipitating property of silver | ◯ | X | ◯ | ◯ | ◯ | ◯ |

TABLE 3

| | | | | | Comparative | |
|---|---|---|---|---|---|---|
| | | NV | Example 9 | | Example 7 | |
| | | % | solids | solution | solids | solution |
| II-1:Main material of | a1:acrylic polyol | 50 | 60 | 120 | 60 | 120 |
| coating composition (a) | a2:CLPP modified Ac | 47 | 25 | 53 | 25 | 53 |
| | a3:CLPP | 20 | 15 | 75 | 15 | 75 |
| subtotal | | | 100 | | 100 | |
| cyclohexane | | | | 26 | | 50 |
| toluene | | | | 111 | | 87 |
| total | | | (100) | 385 | | 385 |
| NV % | | | | 26 | | 26 |
| II-2:Curing agent: | b2: blocked NCO | 38 | 8 | 21 | 8 | 21 |
| solution | compound | | | | | |

| | | | | |
|---|---|---|---|---|
| † | 108 | 406 | 108 | 406 |
| Final one-component coating composition | 26.6 | | 26.6 | |
| nonvolatile (NV) % | | | | |

| | | |
|---|---|---|
| Top clear (c) | clear (c1) | clear (c1) |
| Adhesion | ◯ | ◯ |
| Appearance (transparency. gloss, interference | ◯ | X |
| fringe, smoothness) | | |
| Storage stability | ◯ | X |
| Precipitating property of silver | ◯ | ◯ |

From the results in Table 1, 2 and 3, it is apparent that the inmold decoration products obtained by using the coating with both primer and base coating function of the present invention are excellent in properties of the precipitating property of silver, the adhesion of a coating film and the coating film appearance. On the other hand, it is apparent that the inmold decoration products of Comparative Examples are poor in either of the properties and therefore are not suitable for use.

### INDUSTRIAL APPLICABILITY

Since the clear coating composition of the present invention has the excellent adhesion of a base coating film to a polyolefin substrate and to a silver-plating layer, and has the excellent appearance properties, it can be used for coating in automobile interior parts such as a meter cluster, a center cluster, a center console, etc.; automobile exterior parts such as wheel caps, a bumper braid, wheel garnishes, a grille radiator, a back panel, door mirror covers, door handles, etc.; and applications other than automobile's parts such as a air conditioner's housing, a cellular phone, a notebook computer, a cosmetic case, etc.

1. A coating with both primer and base coating function for an inmold decoration product, used in a method of producing inmold decoration products obtained by forming a multilayer coating film comprising a silver-plating layer,
said multilayer coating film being obtainable by forming a coating film layer with both primer and base coating function, a silver-plating layer and a top clear coating film layer on a polyolefin substrate,
wherein said coating with both primer and base coating function comprises a main material (a) based on acrylic polyol (a1), a chlorinated polyolefin modified acrylic resin (a2) and a chlorinated polyolefin resin (a3), and a polyisocyanate curing agent (b),
the % by weight of the solids of said (a1), (a2) and (a3) are 40 to 80%, 5 to 45% and 1 to 35%, respectively, and
the main material (a) contains cyclohexane in an amount 5 to 45 parts by weight per 100 parts by weight of the solids in the main material.

2. The coating with both primer and base coating function for an inmold decoration product according to claim 1,
wherein said polyisocyanate curing agent (b) is a polyisocyanate compound and
said coating with both primer and base coating function for an inmold decoration product is a two package polyurethane coating composition.

3. The coating with both primer and base coating function for an inmold decoration product according to claim 1,
wherein said polyisocyanate curing agent (b) is a polyisocyanate compound blocked with a blocking agent and
said coating with both primer and base coating function for an inmold decoration product is a one-component polyurethane coating composition.

4. A method of producing inmold decoration products comprising the steps of
(1) forming a coating film layer with both primer and base coating function by applying the coating with both primer and base coating function for an inmold decoration product according to any one of claims 1 to 3 onto a polyolefin substrate;
(2) forming a silver-plating layer on the coating film with both primer and base coating function formed by said step (1); and
(3) forming a top clear coating film layer on the silver-plating layer formed by said step (2).

5. An inmold decoration product,
which is produced by the method of producing inmold decoration products according to claim 4.
